(19) United States
(12) Patent Application Publication
(10) Pub. No.: US 2008/0164042 A1
(43) Pub. Date: Jul. 10, 2008

(54) Hand-held power tool with pneumatic percussion mechanism

(76) Inventor: Eric Mascall, Shanghai (CN)

Correspondence Address: ABELMAN, FRAYNE & SCHWAB, 666 THIRD AVENUE, 10TH FLOOR, NEW YORK, NY, 10017, US

(21) Appl. No.: 12/002,247

(22) Filed: Dec. 14, 2007

(30) Foreign Application Priority Data
Dec. 18, 2006 (DE) 10 2006 000 533.3

(51) Int. Cl. B25D 17/24; B25D 9/04

(52) U.S. Cl. 173/201

(57) ABSTRACT

A hand-held power tool includes a percussion mechanism (2) having a percussion piston (5) for impacting at least one anvil (8, 8′a, 8′b) displaceable in a guide tube (6) between two, spaced from each other axial stops (7a, 7b) provided in the guide tube (6), and an impact sleeve (10, 10′) arranged coaxially with the at least one anvil (8, 8′a, 8′b), axially displaceable within limits between two outer radial bands (9a, 9b, 9′) formed on the at least one anvil (8, 8′a, 8′b), and having an outer diameter (A) smaller than an inner diameter (I) of the guide tube (6).

### BACKGROUND OF THE INVENTION

1. Field of the Invention

The present invention relates to a hand-held power tool such as chisel hammer or a hammer drill and including a percussion mechanism having a percussion piston driven by an air spring and impacting an anvil which is axially displaceable, within limits, in a guide tube and applies blows to an end surface of a working tool likewise axially displaceable within certain limits.

2. Description of the Prior Art

At unusual operational circumstances such as when idle blows are directed toward the working tool, with the power tool being lifted off a constructional component, and when rebound blows, in the direction opposite the direction of a return stroke, are generated upon encountering a hard reinforcing iron, the percussion mechanism comes out of its optimal normal operational condition and generate strong vibrations which should be damped.

International Publication WO 03/024671 discloses a hand-held power tool with a pneumatic percussion mechanism and a damping member and in which the percussion piston has a tapering section with an offset outer cone that frictionally penetrates in a radially narrowing steel ring of the damping member, dissipating a major portion of the motion energy of the percussion piston over a long axial pre-damping region in the visco-elastic damping member.

German Publication DE 3910398 discloses a power tool in which two anvils are arranged within an axially stationary, three-part guide sleeve with an elastomeric damping ring, with the guide sleeve forming, at its end sides, respectively, two inner radial bevels which are repeatedly impacted by respective outer radial bevels of an outer radial bands of the two anvils during an idle blow. The motion energy of the percussion piston is dissipated as a result of contact friction upon the outer radial bevels of the anvils impacting the inner radial bevels of the guide sleeve and of the use of a viscoelastic elastomeric damping ring.

European Publication EP 1238759 discloses a power tool in which the anvil has two axially spaced outer radial bands which pass through an elastomeric damping ring with an inner radial band during an idle blow, with the damping ring expanding radially, absorbing additional motion energy.

German Publication DE 4400779 discloses a power tool in which an anvil is freely axially displaceable in a metal slide sleeve that is preloaded elastically radially outwardly and is frictionally axially displaceable in a guide tube. The slide sleeve forms two, end-side, inner radial bevels with which outer radial bevels of outer radial bands of the anvil are associated, respectively. During an idle blow, the working tool-side inner radial bevel of the slide sleeve expands radially outwardly, whereby the friction force of the slide sleeve increases, and, correspondingly, more motion energy is dissipated.

The remaining motion energy is dissipated by a viscoelastic damping ring that the slide sleeve, together with the anvil, impact.

However, viscoelastic damping rings weaken with time, so that after a prolong use, the idle blow damping is reduced.

Accordingly, an object of the present invention is to provide a power tool with means that would insure a robust, long-lasting damping of idle blows, in particular, without use of viscoelastic damping members.

### SUMMARY OF THE INVENTION

This and other objects of the present invention, which will become apparent hereinafter are achieved by providing a hand-held power tool including a guide tube having two, spaced from each other, axial stops, at least one anvil axially displaceable within limits between the two axial stops, and a percussion mechanism including a percussion piston for impacting the at least one anvil and an air spring for driving the percussion piston. The power tool further includes an impact sleeve arranged coaxially with the at least one anvil axially displaceable within limits between two axially spaced, outer radial bands provided on the at least one anvil and having an outer diameter smaller than an inner diameter of the guide tube.

With an impact sleeve which is freely axially displaceable over the at least one anvil, the anvil forms (during an idle blow) an impact system that, as a result of force impacts acting in opposite directions, takes up a portion of the motion energy of the anvil and transmits it to the impact sleeve. This results from the fact that at a real (not ideally elastic) force impact, due to the contact and inner material friction, a portion of the motion energy constantly dissipates, even when with impact pairing steel/steel with an impact parameter of about 0.95, this portion amounts only to 10% of the force impact. In the anvil unit, at an idle blow, the anvil impacts, at an anvil speed and with a force impact, with its power tool-side outer radial band the impact sleeve, which up to the impact remained stationary (with respect to the power tool). The impact brakes the anvil, while the impact sleeve is accelerated until it impacts the other outer radial band of the anvil, transmitting its motion energy back to the anvil (or the working tool-side second anvil). This exchange of impacts results from a number of force impacts (with a two anvil unit by rebounds of the anvils from the axial stops in the guide tube) until at some point in time, the impact sleeve would have the same end speed as the anvil(s) and would eventually come to a stop as a result of the energy losses. For a successful damping of an idle blow, it is essential that the anvil(s) loose(s) a sufficient amount of energy before it strikes, in its idle blow position, the percussion piston. This is achieved by a satisfactory braking of the anvil or a timely delay of its re-entry in the working region of the impact piston.

Advantageously, the guide tube has an interceptor member for stopping the percussion piston in an idle stroke position of the power tool which interceptor, advantageously, is formed as a springy O-ring that engages in a circumferential radial groove formed in the percussion piston. Thereby, the percussion piston, which occupies the idle blow position (primarily, by deaeration of the air spring), does not move out of the idle blow position, even under action of the gravity force, when the power tool is oriented upward. In addition, the interceptor member increases the energy threshold with which the movable backward (during an idle blow) anvil can impact the percussion piston, without displacing it out of the idle blow position.

Advantageously, the impact sleeve is formed tangentially of two parts, preferably, of two half-shells connected with each other (e.g., by welding), whereby, it is mounted around a one-piece anvil between the two outer radial bands.

Alternatively, the percussion mechanism can have two anvils with each having a single outer radial band and displaceable into the one-piece impact sleeve from outside. No connection of the anvils is necessary as both parts form an axially movable-impact chain that is displaceable only within certain limits.

Advantageously, the mass of the impact sleeve is in a range from 80% to 100% of mass of a single anvil. Thereby, during an idle blow of the anvil, the anvil, which impacts the impact sleeve, which remained stationary until the impact, with its power tool-side outer radial band, at the anvil speed and with a force impact, almost comes to a stop, while the impact sleeve is accelerated almost to the speed of the anvil.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a side partially cross-sectional view of a hand-held power tool according to the present invention;

FIG. 2 a longitudinal cross-sectional view of a section of the power tool shown in FIG. 1, showing the anvil unit; and

FIG. 3 a longitudinal cross-sectional view of another embodiment of a section of the power tool shown in FIG. 1, showing the anvil unit.

### DETAILED DESCRIPTION OF THE PREFERRED EMBODIMENTS

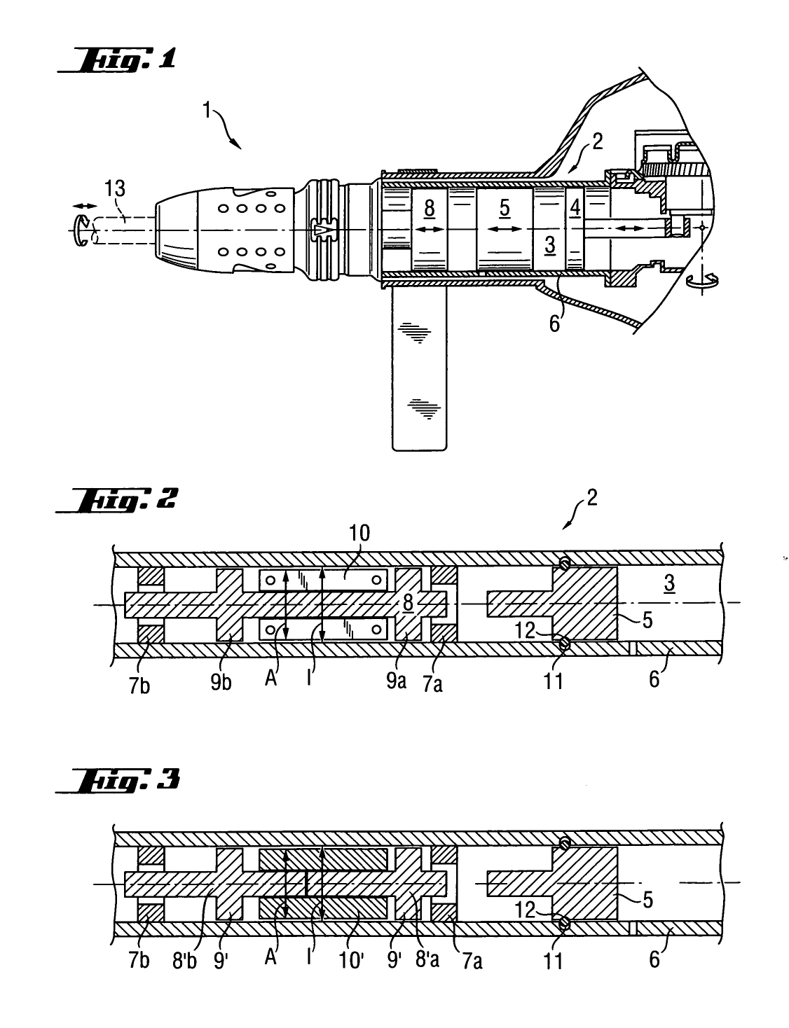

A hand-held power tool 1 according to the present invention which is shown in FIG. 1 and drives rotationally and percussively a working tool 13, includes a percussion mechanism 2 having a driving piston 4 and a percussion piston 5 that is connected with the driving piston 4 by an air spring 3. In the position shown in FIG. 1, the percussion piston 5 impacts an anvil 8 displaceable in a guide tube 6.

As shown in FIG. 2, the anvil 8, which is displaceable in the guide tube 6 between two axial stops 7a, 7b, has two, axially spaced from each other, outer radial bands 9a, 9b between which there is provided an impact sleeve 10 coaxial with the anvil 8 and freely displaceable within limits defined by the bands 9a, 9b. The impact sleeve 10 is formed of two half shells screwed with each other. In the drawing, only one half-shell, which lies behind the cutting plane, is shown. The impact sleeve 10 has an outer diameter A that is only slightly smaller than the inner diameter I of the guide tube 6. The guide tube 6 has an interceptor member 11 in form of a springy O-ring for the percussion piston 5 and which engages in a circumferential radial groove 12 in the percussion piston 5 in the idle blow position shown in the drawings. The mass of a steel-made impact sleeve 10 amounts to 80% of the mass of the likewise steel-made anvil 8.

In FIG. 3, two anvils 8′a and 8′b are axially displaceable within certain limits between two axial stops 7a, 7b of the guide tube 6. The two anvils 8′a, 8′b are displaceable from outside into a one-piece impact sleeve 10′ and contact there each other along their end surfaces. Each of the two anvils 8′a, 8′b has a radially outer band 9′ and 8′. The impact sleeve 10′ has an outer diameter A that is slightly smaller than the inner diameter I of the guide tube 6. The guide tube 6 has an interceptor member 11 in form of a springy O-ring for a percussion piston 5 and which engages in a circumferential radial groove 12 in the percussion piston 5 in the idle blow position shown in the drawings. The mass of a steel-made impact sleeve 10′ amounts to 120% of the mass of the likewise steel-made anvil 8′a, 81′b.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A hand-held power tool, comprising a guide tube (6) having two, spaced from each other, axial stops (7a, 7b); at least one anvil (8, 8′a, 8′b) axially displaceable within limits between the two axial stops (7a, 7b) and having two, axially spaced from each other, outer radial bands (9a, 9b, 9′); a percussion mechanism (2) including a percussion piston (5) for impacting the at least one anvil (8, 8′a, 8′b) and an air spring (3) for driving the percussion piston; and an impact sleeve (10, 10′) arranged coaxially with the at least one anvil (8, 8′a, 8′b), axially displaceable within limits between the two outer radial bands (9a, 9b, 9′) of the at least one anvil (8, 8′a, 8′b), and having an outer diameter (A) smaller than an inner diameter (I) of the guide tube (6).

2. A hand-held power tool according to claim 1, wherein the guide tube (6) has an interceptor member (11) for stopping the percussion piston (5) in an idle stroke position of the power tool.

3. A hand-held tool according to claim 1, wherein the impact sleeve (10) is formed tangentially of two parts.

4. A hand-held power tool according to claim 1, wherein the percussion mechanism (2) has two anvils (8′a, 8′b) with each having a single outer radial band (9) and displaceable into the impact sleeve (10′).

5. A hand-held power tool according to claim 1, wherein mass of the impact sleeve (10′) amounts to 80%-120% of mass of the at least one anvil (8).

6. A hand-held power tool according to claim 4, wherein mass of the impact sleeve (10′) amounts to 80%-120% of the mass of a single anvil (8′a, 8′b).
